(19) United States
(12) Patent Application Publication
(10) Pub. No.: US 2006/0020765 A1
(43) Pub. Date: Jan. 26, 2006

(54) Configuration of components for a transition from a low-power operating mode to a normal-power operating mode

(76) Inventors: Peter Mahrla, Zorneding (DE); Uwe Hildebrand, Erlangen (DE); David Sellar, München (DE); Michael Goedecke, München (DE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 11/158,803

(22) Filed: Jun. 22, 2005

(30) Foreign Application Priority Data
Jul. 2, 2004 (DE) 10 2004 032 237.6

(51) Int. Cl. G06F 12/00; G06F 1/26

(52) U.S. Cl. 711/170; 713/330

(57) ABSTRACT

The invention relates to a processor/memory system having at least one processor, a memory unit, and at least one memory control unit for controlling accesses from the at least one processor to the memory unit. The system also includes a hardware configuration unit operable to configure the at least one memory control unit when the at least one memory control unit changes from a low-power operating mode to a normal-power operating mode.

### REFERENCE TO RELATED APPLICATIONS

This application claims the benefit of the priority date of German application DE 10 2004 032 237.6, filed on Jul. 2, 2004, the contents of which are herein incorporated by reference in their entirety.

### FIELD OF THE INVENTION

The invention relates to the configuration of components and/or of entire parts of a circuit arrangement that transition from a low-power operating mode to a normal-power operating mode. The invention relates in particular to such a configuration of a control unit which controls the accesses from two or more processors to a memory unit in a processor/memory system, and to the restoration of the contents of volatile memory elements in a circuit arrangement on returning to a normal-power operating mode from a low-power operating mode.

### BACKGROUND OF THE INVENTION

In the present patent application, the expression a low-power operating mode means an operating mode in which the power requirement of the relevant component or the relevant circuit arrangement is reduced and in which the component or the circuit arrangement can accordingly not carry function for which it or they are actually designed. A low-power operating mode is, for example, a standby operating mode. The expression a low-power operating mode also means a temporary disconnection from the supply voltage. In a normal-power operating mode, the functions of the relevant component or of the relevant circuit arrangement for which the component or the circuit arrangement is designed can be carried out. In a processor/memory system which is designed to allow two or more processors to access one memory unit, one problem that occurs is that a control unit which controls the accesses from the processors to the memory unit loses its register values on being temporarily run down to a low-power operating mode. When the control unit is subsequently “woken up”, these register values are thus no longer available to the control unit. The configuration state of the control unit is thus undefined after running up to the normal-power operating mode. However, an accurate configuration state of the control unit is necessary since only one such state ensures that the control unit interacts correctly with the memory unit and that the data outputs of the control unit via which the processors obtain the required data are set up correctly. It is thus necessary to reload the registers in the control unit with the data that is required for its configuration, after the control unit has returned to the normal-power operating mode.

In conventional processor/memory systems, the register values which are required for configuration of the control unit are stored in a non-volatile memory and are loaded in the control unit after the control unit returns to the normal-power operating mode. This process is controlled by one of the processors. This procedure has the disadvantage that the processor which is responsible for the configuration of the control unit must itself be in a normal-power operating mode for each such configuration process. A situation can occur, for example, in which all of the processors and the control unit are in a low-power operating mode. As soon as one of the processors is “woken up” and this processor requires data from the memory unit, not only the control unit but also the processor which is responsible for its configuration are returned to the normal-power operating mode. In a situation such as this, this processor therefore cannot be left in the low-power operating mode. This results in an increase in the processor/memory system power consumption. Furthermore, a high degree of software complexity is required for controlling the processor/memory system.

The problem described above occurs not only in the case of processor/memory systems, but in an entirely general form in the case of circuit arrangements which have a circuit element which can be run down to a low-power operating mode. On subsequent activation of this circuit element, the contents of volatile memory elements and registers are no longer available. In order to reproduce the state which existed before running down to the low-power operating mode, the contents of volatile memory elements and registers must be loaded, before the running-down process, into a memory which retains its content during the low-power operating mode of the relevant circuit element. Once the normal-power operating mode has been restored, the previously temporarily stored data can be transferred back to the appropriate memory elements and registers in the relevant circuit element. The described temporary storage of the data and its subsequent writing back to the volatile memory elements and registers is carried out by one processor in conventional circuit arrangements. This results in an increased power consumption, and in complex software.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present one or more concepts of the invention in a simplified form as a prelude to the more detailed description that is presented later.

The invention is directed to a circuit arrangement, at least one part of which can be in a low-power operating mode at times. When a circuit element of the arrangement is subsequently run up or brought up to a normal power mode, the original state of the circuit element is reproduced with relatively little complexity. One particular aim of the present invention is to provide a processor/memory system having a control unit for controlling the accesses from the processors to the memory unit, in which case the control unit can be temporarily transferred to a low-power operating mode and the processor/memory system has a reduced power consumption and less software complexity than conventional systems. The invention also includes a method for changing a processor in the said processor/memory system to the low-power operating mode. The invention further includes a method for returning the control unit in the processor/memory system to the normal-power operating mode.

The processor/memory system according to the invention comprises at least one processor, a memory unit, at least one first memory control unit and a configuration unit.

If the processor/memory system has two or more processors, the memory unit is used jointly by the processors. The at least one first memory control unit is arranged between the at least one processor and the memory unit and controls the accesses from the at least one processor to the memory unit, that is to say the at least one processor accesses the data that is stored in the memory unit via the at least one first memory control unit. The configuration unit is operable to configure the at least one first memory control unit when the at least one first memory control unit changes from a low-power operating mode to a normal-power operating mode. The configuration unit, in one example, is designed only for this task, and has no further tasks. The configuration unit may comprise a hardware component. In the present patent application, the expression a hardware component means a component which is not able to process machine codes. In contrast to this, programs in machine code can be run on software components, such as processors.

In the processor/memory system according to one embodiment of the invention, the configuration of the at least one first memory control unit is carried out by a hardware unit on returning from a low-power operating mode to a normal-power operating mode, and not by a processor as in the case of conventional processor/memory systems. Thus, in contrast to conventional processor/memory systems, the at least one processor according to the invention does not carry out this task. This means that the at least one processor can in principle remain in a low-power operating mode when the at least one first memory control unit returns to the normal-power operating mode. This results in the power consumption of the processor/memory system being reduced, and in a reduction in the complexity of the software that is running on the processors.

The configuration unit comprises, in one example, a data transfer unit and a buffer store. The data transfer unit is configured such that, when the at least one first memory control unit changes from a low-power operating mode to a normal-power operating mode, first configuration data which has previously been stored in the buffer store is written to registers in the at least one first memory control unit. The first configuration data is used for configuration of the at least one first memory control unit.

The data transfer unit is in one embodiment comprises hardware. The buffer store may be, for example, a solid-state RAM, a FIFO memory or a similar memory component which is suitable for the storage of the first configuration data. In particular, the buffer store must not lose its memory contents when the at least one first memory control unit is operating at low power. In consequence, the buffer store is either designed such that it retains its contents even during low-power operation, or else the buffer store is not itself run down during low-power operation of the at least one first memory control unit.

Furthermore, the data transfer unit transfers first configuration data from the registers in the at least one first memory control unit to the buffer store, preferably before the at least one first memory control unit is run down to a low-power operating mode. This measure means that the configuration of the at least one first memory control unit, as it existed before it was run down, can be reproduced after the end of the low-power operating mode.

According to one embodiment of the invention, a second control unit is provided, which controls the configuration unit. The second control unit comprises, in one example, a hardware unit. The second control unit may, for example, transmit control signals to the configuration unit in order to cause the latter to carry out a data transfer, as is required as a result of a change in the operating mode, between the at least one first memory control unit and the buffer store.

A further embodiment of the processor/memory system according to the invention provides for the configuration unit or, if appropriate, the data transfer unit to be programmable.

It is possible in one example of the invention to provide for two or more sets of first configuration data to be stored in the buffer store. This measure makes it possible to operate the at least one first memory control unit in various normal-power operating modes, with the normal-power operating modes each being characterized by different sets of first configuration data.

By way of example, it is possible to stipulate before running down to the low-power operating mode which of the sets of first configuration data will be loaded into the registers in the at least one memory control unit on returning to the normal-power operating mode. Appropriate control information is then stored in the buffer store. As an alternative to this, it is also possible to provide for this control information to be produced by the second control unit on returning to a normal-power operating mode.

It is also advantageous in one example to select one processor from the two or more processors which is authorized as the only processor to configure the configuration unit or, if appropriate, the data transfer unit. This task may comprise, for example, the processor stipulating the values of which registers are written from the at least one first memory control unit to the buffer store.

The selected processor can in one example produce two or more sets of second configuration data for the configuration of the configuration unit or the data transfer unit. These second configuration data sets may be stored in the buffer store. By way of example, this measure makes it possible to provide a specific second configuration data set for each of the processors. If only one processor is woken up, while the other processors remain in a low-power operating mode, the at least one first memory control unit uses one specific second configuration data set for configuration purposes, and only to the extent that is necessary for operation of the processor that has been woken up.

In this context, it is advantageous for the processor that has been woken up to be able to select one of the second configuration data sets.

The data transfer unit may, for example, be in the form of a DMA (direct memory access) controller.

The memory unit and the at least one first memory control unit are, in one example, always in a low-power operating mode at the same time. This reduces the power consumption of the processor/memory system according to the invention.

A first method according to the invention is used for changing at least one processor in the processor/memory system according to the invention from a low-power operating mode to a normal-power operating mode. This is based on the assumption that the at least one first memory control unit is in a low-power operating mode at the start of the process. For this reason, the at least one first memory control unit is first of all changed to the normal-power operating mode. To do this, a supply voltage is applied in a first method step to the at least one first memory control unit, and the at least one first memory control unit is configured by the configuration unit in a second method step. Once all of the preconditions for normal-power operation of the at least one first memory control unit have been satisfied, the operating mode of the at least one processor can be changed from a low-power operating mode to a normal-power operating mode, and the at least one processor can now access the memory unit via the at least one first memory control unit.

The first method according to the invention ensures that the relevant processor does not access the memory unit unless the at least one first memory control unit is fully operable.

The change of the at least one first memory control unit to the normal-power operating mode is initiated in one example by a control signal which is produced by the second control unit.

The second method according to the invention makes it possible for the at least one first memory control unit in the processor/memory system according to the invention to change from a normal-power operating mode to a low-power operating mode. In a first method step, the first configuration data, which is contained in the registers in the at least one first memory control unit, is written to the buffer store. In a second method step, the at least one first memory control unit is disconnected from its supply voltage.

The first method step is started in one example by a control signal that is produced by the second control unit.

A further embodiment of the invention relates to a circuit arrangement having a circuit element which has memory elements which lose their memory contents during a low-power operating mode. The circuit arrangement according to the invention also contains a memory unit which, in contrast to the memory elements in the circuit element, retains its memory contents during a low-power operating mode of the circuit element. In addition, a DMA controller is provided, which is designed to write the data that has been stored in predetermined memory elements in the circuit element to the memory unit before the circuit element changes from a normal-power operating mode to a low-power operating mode, and to transfer this data back to the memory elements again after the circuit element has returned to the normal-power operating mode.

The circuit arrangement according to the invention reduces the load on a processor which is responsible for the data transfer in the course of a change in the operating mode in conventional circuit arrangements. This reduces the chip area, the power consumption and the software complexity. Furthermore, the DMA controller does not result in any additional complexity since it is provided in any case in most microcontroller systems.

One embodiment of the circuit arrangement according to the invention provides two lists or tables which contain information about the data transfers to be carried out when an operating mode change occurs. A first list contains the information which is required for the circuit element to change from the normal-power operating mode to the low-power operating mode. The second list relates to the opposite situation, that is to say when the circuit element changes from the low-power operating mode to the normal-power operating mode.

Both lists contain, for example, details about the start and destination addresses of the data transfers to be carried out, details about the increment operations relating to the start and destination addresses after a data transfer has been carried out, as well as details about the number of data transfers to be carried out.

In one example, the first list and/or the second list are stored in the memory unit. This ensures that the two lists are available after the end of the low-power operating mode.

The memory elements in the circuit element, which lose their memory contents during a low-power operating mode may, for example, be volatile memories and/or registers.

A hardware unit or a processor is provided in one example which is designed to produce control signals which cause the DMA controller to carry out the necessary data transfers before the circuit element changes from a normal-power operating mode to a low-power operating mode, and/or after the circuit element returns to the normal-power operating mode.

Furthermore, the DMA controller may also advantageously itself be changed to a low-power operating mode. In this case, the DMA controller is designed such that it loads the configuration data which is required for its configuration from the memory unit during running up from the low-power operating mode.

To the accomplishment of the foregoing and related ends, the invention comprises the features hereinafter fully described and particularly pointed out in the claims. The following de-scription and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The invention will be explained in more detail in the following text in an exemplary form and with reference to the drawings, in which:

FIG. 1 is a block diagram illustrating a processor/memory system 1 according to the prior art;

FIG. 2 is a block diagram illustrating a processor/memory system 10 as an exemplary embodiment of the processor/memory system according to the invention;

FIG. 3 is a flowchart illustrating a method of operation of the processor/memory system 10 illustrated in FIG. 2;

FIG. 4 is a more detailed part of the block diagram of the processor/memory system 10 as illustrated in FIG. 2; and

FIG. 5 is a block diagram illustrating a circuit arrangement 300 as an exemplary embodiment of the circuit arrangement according to the invention.

### DETAILED DESCRIPTION OF THE INVENTION

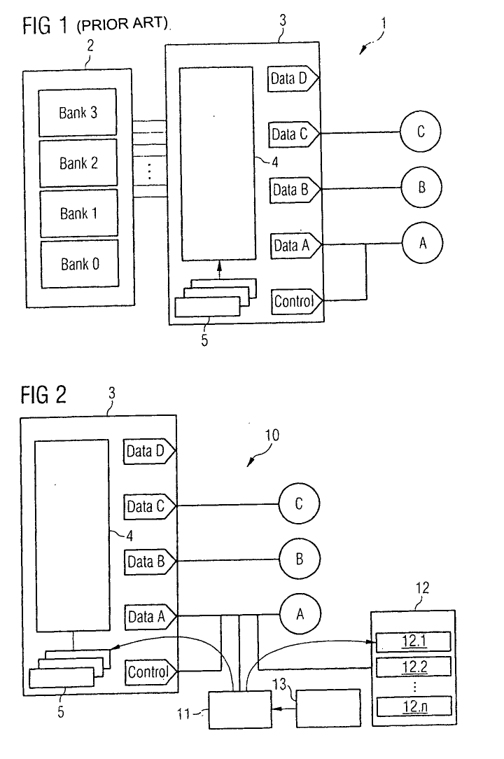

FIG. 1 shows a block diagram of a conventional processor/memory system 1. The processor/memory system 1 comprises processors A, B and C, an SDRAM 2 and an SDRAM controller 3. The SDRAM controller 3 is connected between the processors A, B and C on the one hand, and the SDRAM 2.

The processors A, B and C use the SDRAM 2 as a common memory unit. The SDRAM controller 3 controls the accesses from the processors A, B and C to the SDRAM 2. The data interchange between the processors A, B and C and the SDRAM 2 takes place via the data inputs and outputs Data A, Data B and Data C of the SDRAM controller 3. In order to allow data transmission and control, the SDRAM controller 3 has an access and control unit 4. The access and control unit 4 is connected to registers 5, in which configuration data about a control input and output Control is stored. The configuration data stored in the registers 5 ensures correct interaction between the SDRAM controller 3 and the SDRAM 2. Furthermore, the configuration data is used to configure the data inputs and outputs Data A, Data B and Data C. In the processor/memory system 1 illustrated in FIG. 1, the configuration data is generated by the processor A, and is written to the registers 5.

If the SDRAM controller 3 is in a low-power operating mode, that is to say for example in the standby operating mode, and is “woken up” therefrom, for example, because one of the processors A, B or C wishes to access the SDRAM 2, the configuration data must be once again written from the processor A to the registers 5 since the contents of the registers 5 will have been erased during the low-power phase of the SDRAM controller 3. In order to make it possible to write the configuration data to the registers 5, the processor A must be in a normal-power operating mode. Assuming that the processor A is in a low-power operating mode at this time, it will thus likewise be “woken up”. In consequence, the processor A must return to its normal-power operating mode whenever the overall processor/memory system 1 is in a low-power operating mode and one of the processors B or C wishes to access the SDRAM 2.

FIG. 2 illustrates a processor/memory system 10 as one exemplary embodiment of the processor/memory system according to the invention. Since some of the components in the processor/memory systems 1 and 10 are identical, these components are provided with the same reference symbols in FIGS. 1 and 2. The SDRAM 2 in the processor/memory system 10 is not illustrated in FIG. 2.

In the processor/memory system 10, the processor A also has the task of generating the configuration data for the SDRAM controller 3, and of storing this in the registers 5. In contrast to the conventional processor/memory system 1 illustrated in FIG. 1 the configuration data is, however, not written back into the registers 5 by the processor A when the SDRAM controller 3 returns to the normal-power operating mode. In fact, this data transfer is carried out by a data transfer unit (save-restore engine) 11 in the processor/memory system 10. The data transfer unit 11 is in the form of a hardware unit.

In order that the data transfer unit 11 can still have the configuration data available after a low-power phase, the configuration data is written by the data transfer unit 11 to a buffer store (data shadow store) 12 before the SDRAM controller 3 is run down from a normal-power operating mode to a low-power operating mode. When the SDRAM controller 3 returns to the normal-power operating mode, the configuration data is written back again to the registers 5 in the SDRAM controller 3 from the buffer store 12.

A control unit (power state machine) 13 signals to the data transfer unit 11 that the SDRAM controller 3 has changed its operating mode. The control unit 13 is likewise in the form of hardware. After receiving a control signal from the control unit 13, the data transfer unit 11 can autonomously carry out the required read/write processes between the registers 5 in the SDRAM controller 3 and the buffer store 12.

The buffer store 12 has registers 12.1 to 12.n, in which the register values loaded from the registers 5 in the SDRAM controller 3 are stored. In order to ensure that the registers 12.1 to 12.n do not lose their register contents while the SDRAM controller 3 is in a low-power operating mode, the buffer store 12 is not disconnected from its voltage supply during these time periods. The buffer store 12 may, for example, be in the form of a solid-state RAM or an FIFO memory.

It is possible to provide for two or more sets of configuration data, which can be loaded into the registers 5 of the SDRAM controller 3, to be stored in the buffer store 12. This measure makes it possible to operate the SDRAM controller 3 in various normal-power operating modes.

By way of example, it is possible to stipulate which of the sets of configuration data will be loaded in the registers 5 on returning to the normal-power operating mode, before running down to the low-power operating mode. Appropriate control information is then stored in the buffer store 12. As an alternative to this, it is also possible to provide for this control information to be produced by the control unit 13 on returning to a normal-power operating mode.

The data transfer unit 11 is configured by the processor A, that is to say the processor A specifies the contents of which registers 5 in the SDRAM controller 3 will be transferred to the buffer store 12 while running down to the low-power operating mode, and to which registers in the buffer store 12 these values will be written. Since this configuration data for the data transfer unit 11 must not be erased, the data transfer unit 11 must not be run down.

As soon as the data transfer unit 11 has been configured once by the processor A, the transitions between low-power and normal-power operating modes can be carried out completely by hardware units.

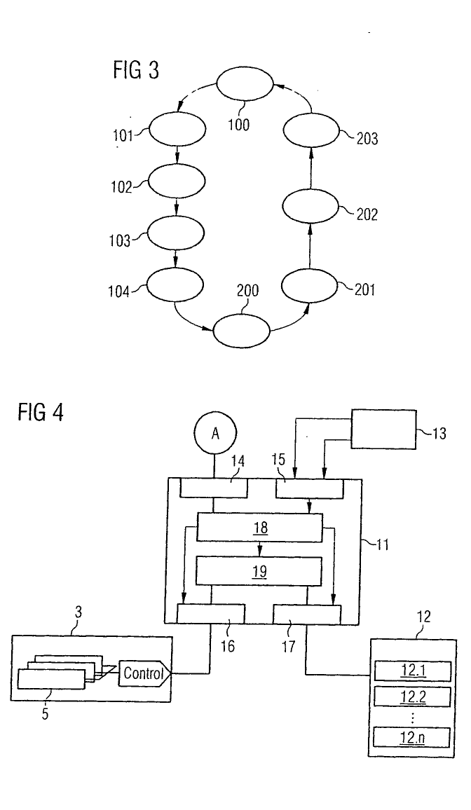

FIG. 3 shows a flowchart of the method steps to be carried out for transitions between a normal-power operating mode 100 and a low-power operating mode 200.

The transition from the normal-power operating mode 100 to the low-power operating mode 200 will be considered first of all. This transition is initiated by a trigger signal. This trigger signal is either generated directly by the processor A in its function as the system master processor, or it is generated automatically as soon as all the processors A, B and C are in a low-power operating mode.

The control unit 13 then signals to the data transfer unit 11 that the values should be written from the predetermined registers 5 to the registers in the buffer store 12. This data transfer is carried out by the data transfer unit 11 in a method step 101. The SDRAM 2 activates its self-refresh mode in a subsequent method step 102. Before the supply voltage for the SDRAM controller 3 is switched off in a method step 104, the setting of the SDRAM controller 3 is reset in a method step 103. The SDRAM controller 3 then reaches the low-power operating mode 200.

Once again, the transition from the low-power operating mode 200 to the normal-power operating mode 100 is initiated by a trigger signal. This trigger signal is either generated directly by the processor A in its function as the system master processor, or is generated automatically as soon as one of the processors A, B and C has “woken up”.

The supply voltage for the SDRAM controller 3 is connected again in a method step 201. The reset mode of the SDRAM controller 3, which is activated in the method step 103, is deactivated in a method step 202.

The control unit 13 then generates a control signal in order to indicate to the data transfer unit 11 that, in a method step 203, it should write the data that has been transferred to the buffer store 12 in the method step 101 back to predetermined registers 5 in the SDRAM controller 3 in a method step 203. This restores the SDRAM controller 3 to the normal-power operating mode 100.

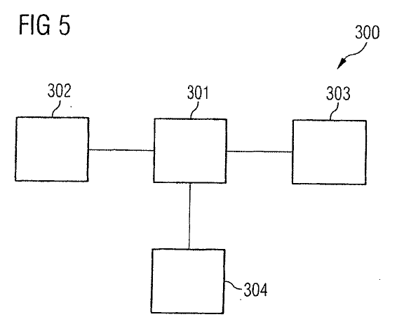

FIG. 4 shows a detail of the processor/memory system 10 illustrated in FIG. 2, in which the data transfer unit 11 is illustrated in more detail.

In the present example, the registers 5 in the SDRAM controller 3 have successive addresses, and the buffer store 12 is part of a solid-state RAM. The data transfer unit 11 can thus be produced with the aid of a DMA controller, with the DMA controller transferring data from the registers 5 in the SDRAM controller 3 to the solid-state RAM in a memory-to-memory transfer mode.

In FIG. 4, the reference symbols 14 to 17 denote interfaces of the data transfer unit 11 to components which are connected to them. The data transfer unit 11 uses the interface 15 to receive the control signals which are generated by the control unit 13 and which are used to initiate the data transfer processes described above.

Furthermore, the data transfer unit 11 has central control logic 18 with configuration registers, and has DMA channel logic 19.

It is possible to provide for the processor A to produce two or more sets of configuration data for the configuration of the data transfer unit 11. These configuration data sets are stored in the buffer store 12. The processors A, B and C can select from the sets stored there the one set which is suitable for the respective situation.

A trigger signal indicates to the data transfer unit 11 which configuration data set should be loaded from the buffer store 12 in its configuration registers. The configuration of the data transfer unit can thus also be changed by the processors B and C without the processor A being directly involved in this configuration process.

FIG. 5 shows the block diagram of a circuit arrangement 300 as one exemplary embodiment of the circuit arrangement according to the invention. The circuit arrangement 300 contains a DMA controller 301, which is connected between a circuit element 302 of the circuit arrangement 300 and a buffer store 303. Furthermore, the DMA controller 301 is connected to a control unit 304.

The circuit element 302 is designed such that it can be changed to a low-power operating mode when required. Since the registers and the volatile memory elements in the circuit element 302 lose their contents in the low-power operating mode, these contents must be temporarily stored in the buffer store 303 before the circuit element 302 is run down to the low-power operating mode. This measure ensures that the temporarily stored data will be available when the circuit element 302 is subsequently “woken up”, and can be loaded in the circuit element 302 again.

The task of the DMA controller 301, which is arranged between the circuit element 302 and the buffer store 303, is to carry out the data transfers, as described above, when the operating mode changes. For this purpose, the DMA controller 301 has access to two lists, each of which contain the required information for one data transfer direction. Each list contains the start and destination addresses, the increment operations for the start and destination addresses, and the number of data transfers to be carried out. Sequences of data transfers can also be written in each list. In this case, the data for each data transfer block is read successively and automatically by the DMA controller 301. The two lists may, for example, be stored in the buffer store 303.

As soon as the circuit element 302 is intended to be changed to a low-power operating mode, this is signalled to the DMA controller 301 by the control unit 304, in response to which the DMA controller 301 carries out the data protection measures described in one list. After completion of this data protection process, the circuit element 302 can be disconnected from its supply voltage.

After the end of the low-power phase, the DMA controller 301 once again receives a control signal from the control unit 304 so that it once again writes the data that has previously been temporarily stored to the registers and volatile memory elements in the circuit element 302. A microcontroller which is arranged in the circuit arrangement 300 cannot access the circuit element 302 again until this process has been completed. Should the microcontroller also have been run down, then the microcontroller is “woken up” only after completion of the described data transfer process.

Furthermore, it is also possible for the DMA controller 301 to itself be run down to a low-power operating mode. In this case, the DMA controller 301 must be designed such that it configures itself—immediately after it has been woken up—by loading data from predetermined addresses in the buffer store 303 into its registers.

The control unit 304 may either be part of the microcontroller, or may be a hardware unit.

The buffer store 303 may be located on the same chip as the DMA controller 301 and the circuit element 302, or else may be on a separate chip.

The circuit arrangement 300 may, for example, be used in mobile radios whose memory elements are generally in the form of volatile SRAM elements. The standby operating mode is obligatory in the GSM Standard as soon as the mobile radio is not in an active phase. This makes it possible to keep the battery consumption low. As soon as the mobile radio must be able to receive incoming calls, the duration of the active phases is typically only a few tens of milliseconds, while the inactive phases may last for up to 2.5 seconds.

DRAM memory elements can be used in the preferred form as buffer stores in mobile radios since they are able to temporarily store large amounts of data with a wide bandwidth. Special DRAMs with low power consumption and which are optimized to require little “refresh” current per bit are particularly suitable for this purpose. The circuit arrangement according to the invention makes it possible to shift the majority of the logic switching of the mobile radio to a standby operation mode, when required.

While the invention has been illustrated and described with respect to one or more implementations, alterations and/or modifications may be made to the illustrated examples without de-parting from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

1. A processor/memory system, comprising:
at least one processor;
a memory unit;
at least one first memory control unit configured to control accesses from the at least one processor to the memory unit; and
a hardware configuration unit operable to configure the at least one first memory control unit when the at least one first memory control unit changes from a low-power operating mode to a normal-power operating mode.

2. The processor/memory system of claim 1, wherein the configuration unit comprises a data transfer unit and a buffer store, wherein the data transfer unit is configured to write first configuration data for the configuration of the at least one first memory control unit from the buffer store to registers in the at least one first memory control unit, when the at least one first memory control unit changes from a low-power operating mode to a normal-power operating mode.

3. The processor/memory system of claim 2, wherein the data transfer unit is further configured to write first configuration data from the registers in the at least one first memory control unit to the buffer store before the at least one first memory control unit changes from a normal-power operating mode to a low-power operating mode.

4. The processor/memory system of claim 1, further comprising a second control unit configured to control the configuration unit, wherein the second control unit comprises hardware.

5. The processor/memory system of claim 1, wherein the configuration unit or the data transfer unit is programmable.

6. The processor/memory system of claim 2, wherein the buffer store is configured to store two or more sets of first configuration data for the configuration of the at least one first memory control unit.

7. The processor/memory system of claim 6, wherein before the at least one first memory control unit changes from a normal-power operating mode to a low-power operating mode, control information is stored in the buffer store by the data transfer unit, with the control information providing information as to which set of first configuration data will be written to the registers of the at least one first memory control unit on returning to a normal-power operating mode, or wherein control information is produced by the second control unit on returning to a normal-power operating mode.

8. The processor/memory system of claim 2, wherein a a predetermined processor is operable to configure the hardware configuration unit.

9. The processor/memory system of claim 8, wherein the predetermined processor is configured to produce two or more sets of second configuration data for the configuration of the data transfer unit, and to store these sets in particular in the buffer store.

10. The processor/memory system of claim 9, further comprising at least one further processor configured to select one of the sets of second configuration data for the configuration of the data transfer unit.

11. The processor/memory system of claim 2, wherein the data transfer unit comprises a DMA controller.

12. The processor/memory system of claim 1, wherein the memory unit is likewise configured to enter a low-power operating mode when the at least one first memory control unit is in a low-power operating mode.

13. A method for changing at least one processor in a processor/memory system from a low-power operating mode to a normal-power operating mode, wherein the processor/memory system comprises the at least one processor, a memory unit, at least one first memory control unit configured to control accesses from the at least one processor to the memory unit, and a hardware configuration unit operable to configure the at least one first memory control unit when the at least one first memory control unit changes from a low-power operating mode to a normal-power operating mode, the method comprising:
applying a supply voltage to the at least one first memory control unit;
configuring the at least one first memory control unit with the configuration unit; and
changing the at least one processor from a low-power operating mode to a normal-power operating mode.

14. The method of claim 13, further comprising initiating the application of the supply voltage by producing a control signal by a second control unit.

15. The method of claim 13, wherein configuration unit of the processor/memory system comprises a data transfer unit and a buffer store, wherein the data transfer unit is configured to write first configuration data for the configuration of the at least one first memory control unit from the buffer store to registers in the at least one first memory control unit, when the at least one first memory control unit changes from a low-power operating mode to a normal-power operating mode, the method further comprising:
storing the first configuration data which is stored in the registers of the at least one first memory control unit in the buffer store; and
disconnecting the at least one first memory control unit from the supply voltage.

16. The method of claim 15, wherein the storing of the first configuration data is initiated by a control signal produced by a second control unit.

17. A circuit arrangement, comprising:
a circuit element comprising memory elements that lose their memory contents during a low-power operating mode;
a memory unit configured to retain its memory contents when the circuit element is in a low-power operating mode; and
a DMA controller configured to write data that is stored in predetermined memory elements of the circuit element to the memory unit before the circuit element changes from a normal-power operating mode to a low-power operating mode, and to write the data back to the memory elements after the circuit element returns to the normal-power operating mode.

18. The circuit arrangement of claim 17, wherein the DMA controller is further configured to access a first list of information about a data transfer to be carried out before the circuit element changes from a normal-power operating mode to a low-power operating mode, and a second list of information about a data transfer to be carried out after the circuit element returns to the normal-power operating mode.

19. The circuit arrangement of claim 18, wherein the first list or the second list is stored in the memory unit.

20. The circuit arrangement of claim 17, wherein the memory elements in the circuit element that lose their memory contents during a low-power operating mode, comprise volatile memories or registers.

21. The circuit arrangement of claim 17, further comprising a control unit configured to produce control signals which cause the DMA controller to carry out the necessary data transfers before the circuit element changes from a normal-power operating mode to a low-power operating mode, or after the circuit element returns to the normal-power operating mode.

22. The circuit arrangement of claim 17, wherein the DMA controller is configured to load the configuration data that is required for its configuration from the memory unit during an awakening from a low-power operating mode.
